(19) United States
(12) Patent Application Publication
(10) Pub. No.: US 2023/0096739 A1
(43) Pub. Date: Mar. 30, 2023

(54) DENTAL TREATMENT DEVICE CONFIGURED TO TREAT A PLURALITY OF TEETH OF A HUMAN PATIENT WHILE MINIMIZING DISCOMFORT FOR THE HUMAN PATIENT

(71) Applicants: Matthew Burton, Hinsdale, IL (US); Nicholas Scalabrino, Western Springs, IL (US)

(72) Inventors: Matthew Burton, Hinsdale, IL (US); Nicholas Scalabrino, Western Springs, IL (US)

(21) Appl. No.: 17/955,466

(22) Filed: Sep. 28, 2022

Related U.S. Application Data
(60) Provisional application No. 63/249,375, filed on Sep. 28, 2021.

(51) Int. Cl. A61C 19/06; A61C 7/00

(52) U.S. Cl. CPC A61C 19/066; A61C 7/00; A61C 19/04

(57) ABSTRACT

A dental treatment device configured to treat a plurality of teeth in an oral cavity of a human patient. The device includes a strip adapted to engage the plurality of teeth in the oral cavity, an adhesive layer disposed on a first side of the strip between a top edge and a bottom edge, and a bleaching agent disposed on the first side of the strip between the top edge and the bottom edge. The bleaching agent is configured to bleach the plurality of teeth when the adhesive layer is adhered to the plurality of teeth for the pre-determined period of time. The bottom edge is defined by a plurality of scallops sized to substantially match the plurality of teeth, such that the plurality of scallops are configured to minimize contact between the bleaching agent and gum tissue adjacent the plurality of teeth in the oral cavity.

### CROSS-REFERENCE TO RELATED APPLICATION

The present application claims the priority benefit of U.S. Provisional Application No. 63/249,375, filed Sep. 28, 2021. The entire disclose of each of this application is hereby incorporated by reference.

### FIELD OF THE DISCLOSURE

The present disclosure generally relates to dental treatment devices, and, more particularly, to dental treatment devices for effectively treating a plurality of teeth of a human patient while also minimizing discomfort for the human patient.

### BACKGROUND

Dentists frequently help their human patients whiten, or bleach, their teeth. One known procedure for doing so involves applying a rectangular flexible strip coated with a tooth whitening gel containing peroxide to the teeth for a limited period of time. This known procedure is effective at whitening the teeth to which the flexible strip is applied. However, because the flexible strip has a generally rectangular shape and a standard size, and because humans have different types of teeth—anterior teeth, which include central incisors, lateral incisors, and canine teeth, and posterior teeth, which include premolars and molars—having different shapes, sizes (e.g., heights, radii), and contours, the flexible strip fits some human patients better than others, and within individual human patients, fits some teeth better than others. In many human patients, application of the flexible strip leaves some teeth (e.g., the posterior teeth), or portions thereof, uncovered (and thus untreated). At the same time, the flexible strip covers gum tissue immediately adjacent the teeth, causing the peroxide to contact gum tissue immediately adjacent the teeth and causing discomfort for the human patient. Another known procedure for whitening teeth involves fitting the human patient with a dental tray molded to fit their teeth, and filling the dental tray with the tooth whitening gel. While the shape of the dental tray is customized to fit the human patient, dental trays tend to be uncomfortable, must be worn for longer periods of time, are more expensive, and are easily lost or destroyed (e.g., by a dog).

### SUMMARY

In accordance with one exemplary aspect of the present invention, a dental treatment device configured to treat a plurality of teeth in an oral cavity of a human patient is provided. The dental treatment device includes a strip adapted to engage the plurality of teeth in the oral cavity, an adhesive layer disposed on a first side of the strip between a top edge and a bottom edge, the adhesive layer configured to adhere to the plurality of teeth for a pre-determined period of time, and a bleaching agent disposed on the first side of the strip between the top edge and the bottom edge. The bleaching agent is configured to bleach the plurality of teeth when the adhesive layer is adhered to the plurality of teeth for the pre-determined period of time. The bottom edge is defined by a plurality of scallops sized to substantially match the plurality of teeth, such that the plurality of scallops are configured to minimize contact between the bleaching agent and gum tissue adjacent the plurality of teeth in the oral cavity.

In accordance with another exemplary aspect of the present invention, a dental treatment device configured to treat a plurality of teeth in an oral cavity of a human patient is provided. The dental treatment device includes a strip adapted to engage the plurality of teeth in the oral cavity, an adhesive layer disposed on a first side of the strip between a top edge and a bottom edge, the adhesive layer configured to adhere to the plurality of teeth for a pre-determined period of time, and a bleaching agent disposed on the first side of the strip between the top edge and the bottom edge, the bleaching agent configured to bleach the plurality of teeth when the adhesive layer is adhered to the plurality of teeth for the pre-determined period of time. The dental treatment device also includes a tab extending outward from the strip between the top edge and the bottom edge, the tab configured to facilitate application of the strip to the plurality of teeth or removal of the strip from the plurality of teeth. The dental treatment device further includes one or more relief cuts formed in the strip to allow the strip to be folded over the plurality of teeth when the adhesive layer is adhered to the plurality of teeth for the pre-determined period of time. The bottom edge is defined by a plurality of scallops sized to substantially match the plurality of teeth, such that the plurality of scallops are configured to minimize contact between the bleaching agent and gum tissue adjacent the plurality of teeth in the oral cavity.

In accordance with another exemplary aspect of the present invention a dental treatment device configured to treat a plurality of teeth in an oral cavity of a human patient is provided. The dental treatment device includes a strip adapted to engage the plurality of teeth in the oral cavity, an adhesive layer disposed on a first side of the strip between a top edge and a bottom edge, the adhesive layer configured to adhere to the plurality of teeth for a pre-determined period of time, and a bleaching agent disposed on the first side of the strip between the top edge and the bottom edge, the bleaching agent configured to bleach the plurality of teeth when the adhesive layer is adhered to the plurality of teeth for the pre-determined period of time. The dental treatment device also includes means for sublingually delivering a medicament to the oral cavity, the means for sublingually delivering the medicament to the oral cavity disposed on a second side of the strip opposite the first side.

### BRIEF DESCRIPTION OF THE FIGURES

FIG. 1A is a top view of a first example of a dental treatment device constructed in accordance with the principles of the present disclosure when laid in a flat position;

FIG. 1B is a top view of a second example of a dental treatment device constructed in accordance with the principles of the present disclosure when laid in a flat position;

FIG. 2A is a top view of a third example of dental treatment devices constructed in accordance with the principles of the present disclosure when laid in a flat position;

FIG. 2B is a top view of a fourth example of a dental treatment device constructed in accordance with the principles of the present disclosure when laid in a flat position;

FIG. 3 is a top view of a fifth example of a dental treatment device constructed in accordance with the principles of the present disclosure when laid in a flat position;

FIG. 4 is a side view showing the dental treatment device of FIG. 3 positioned over a first tooth of a plurality of teeth in an oral cavity of a human patient;

FIG. 5 is a side view showing the dental treatment device of FIG. 3 adhered to the first tooth (and the rest of the plurality of teeth) in the oral cavity;

FIG. 6 is a side view showing the dental treatment device of FIG. 3 adhered to a second tooth of the plurality of teeth in the oral cavity;

FIG. 7 is an overhead view showing the arrangement of the dental treatment device of FIG. 3 relative to the second tooth and a third tooth of the plurality of teeth in the oral cavity; and

FIG. 8 is a top view of the dental treatment device of FIG. 1B removably coupled to the dental treatment device of FIG. 1A.

### DETAILED DESCRIPTION

The present disclosure is directed to a dental treatment device configured to treat (e.g., whiten) a plurality of teeth in an oral cavity of a human patient. The disclosed dental treatment device includes a strip adapted to engage the plurality of teeth in the oral cavity and a bleaching agent that is disposed on the strip and is configured to bleach (or whiten) the plurality of teeth when the strip is adhered to the plurality of teeth. At the same time, the strip is anatomically designed so as to better fit the plurality of teeth of the human patient in a manner that better covers the plurality of teeth while also preventing the bleaching agent from reaching the human patient's gums. To this end, the strip has a bottom edge defined by a plurality of scallops that are sized to substantially match the shape, size, and contours of the various plurality of teeth to which the strip is adhered, thereby maximizing contact between the bleaching agent and the plurality of teeth and minimizing contact between the bleaching agent and gum tissue adjacent the plurality of teeth. Accordingly, the disclosed dental treatment device more effectively treats the plurality of teeth of the human patient while also minimizing discomfort and expense for the human patient.

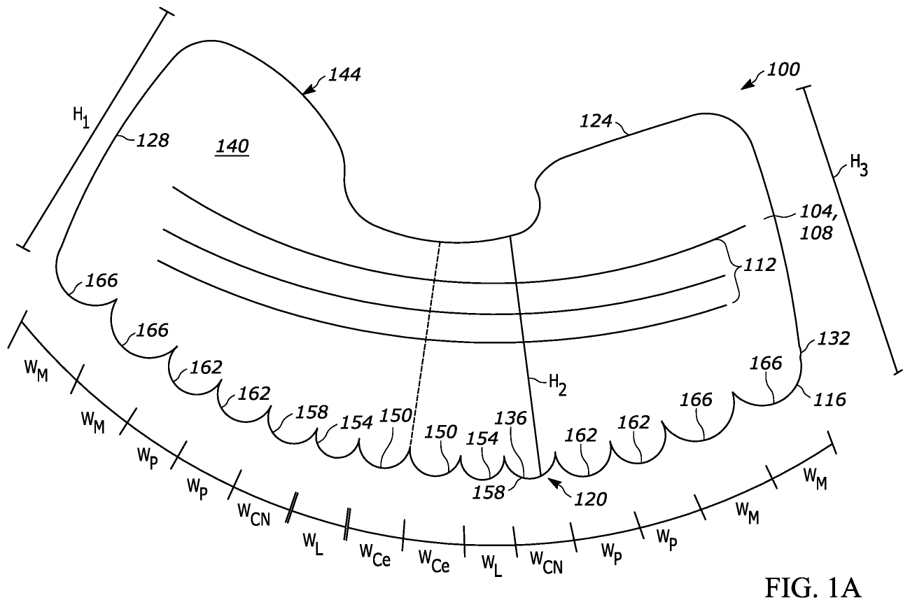

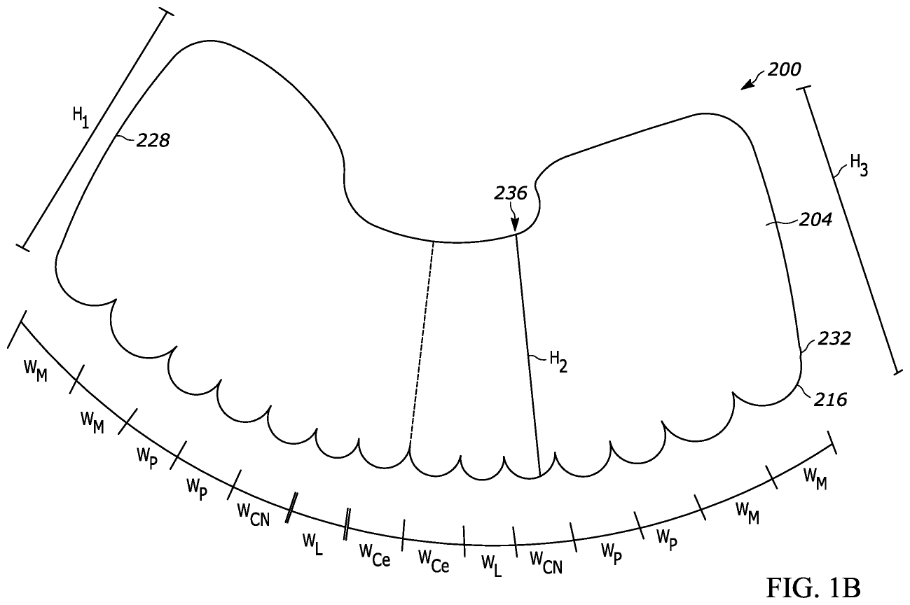

FIG. 1A illustrates a first example of a dental treatment device 100 constructed in accordance with the principles of the present disclosure. The dental treatment device 100 is configured to treat (e.g., bleach or whiten) upper teeth in an oral cavity of a human patient having larger teeth (e.g., an adult male). The dental treatment device 100 generally includes a strip 104 adapted to engage the plurality of teeth in the oral cavity of the human patient, an adhesive layer 108 disposed on the strip 104 and configured to adhere the strip 104 to the plurality of teeth for a pre-determined period of time (e.g., 5 minutes, 15 minutes, 30 minutes, 60 minutes), and a bleaching agent 112 disposed on the strip 104 and configured to bleach (or whiten) the plurality of teeth when the adhesive layer 108 is adhered to the plurality of teeth for the pre-determined period of time. Consistent with the discussion above, the strip 104 is anatomically designed so as to better fit the plurality of teeth of the human patient so as to better cover the plurality of teeth while also preventing the bleaching agent from reaching the human patient's gums. To this end, the strip 104 has a bottom edge 116 defined by a plurality of scallops 120 sized and shaped to substantially match the size and shape of the plurality of teeth to which the strip 104 is adhered.

The strip 104 is generally adapted to engage (and substantially if not entirely cover) the plurality of teeth in the oral cavity to be treated when the adhesive layer 108 contacts the plurality of teeth for the pre-determined period of time. The strip 104, which may be formed of one or more layers, is made of a thin, flexible material such as, for example, a polymeric material (e.g., polyethylene, polypropylene). The strip 104 in this example is disposable (i.e., used for one treatment and then discarded), though in some cases, the strip 104 may be used multiple times.

The strip 104 preferably has a generally wing-like configuration defined by the bottom edge 116, a top edge 124 opposite the bottom edge 116, a first end 128, and a second end 132 opposite the first end 128. In this example, each of the top and bottom edges 124, 116 and the first and second ends 128, 132 are curved, such that portions of the top edge 124 are parallel (or substantially parallel) to the bottom edge 116, and the first and second ends 128, 132 are non-parallel to one another. However, portions of the top edge 124 curve inwards, towards the bottom edge 116, such that these portions of the top edge 124 are not parallel to the bottom edge 116. In turn, the strip 104 has a height that varies along its width. More particularly, the strip 104 has a height H₁ at the first end 128, a height H₂ at a middle portion 136 between the first and second ends 128, 132 that is less than the height H₁, and a height H₃ at the second end 132. In this example, the height H₁ and the height H₃ are each equal to approximately 25 mm, whereas the height H₂ is equal to approximately 19 mm. In other examples, however, the heights H₁, H₂, and H₃ can slightly vary. In any event, it will be appreciated that the strip 104 does not have the same generally rectangular shape typically employed in conventional strips.

The adhesive layer 108 partially or substantially entirely coats a first side 140 of the strip 104 between the top edge 124 and the bottom edge 116. The adhesive layer 108 preferably takes the form of an adhesive such as polyvinylpyrrolidone, glycerin, carbomer, or carboxymethycellulose that is configured to be activated with saliva, such that the adhesive becomes more sticky and adhesive when moistened with saliva. Thus, when the strip 104 is positioned within the oral cavity of the human patient and the adhesive layer 108 is adhered to the plurality of teeth, saliva in the oral cavity will increase the stickiness of the adhesive layer 108, thereby helping to retain the strip 104 on the plurality of teeth.

The bleaching agent 112 also partially or substantially entirely coats the first side 140 of the strip 104 between the top edge 124 and the bottom edge 116 and the first and second ends 128, 132, depending upon the exact volume of the bleaching agent 112 disposed on the strip 104. The bleaching agent 112 includes an active ingredient comprising a peroxide, a perborate, a percarbonate, a persulfate, a metal chlorite, or a combination thereof. The peroxide can include, but is not limited to, hydrogen peroxide, carbamide peroxide, calcium bicarbonate peroxide, sodium bicarbonate peroxide, zinc peroxide, and magnesium peroxide. The perborate can include, but is not limited to, sodium perborate. The persulfate can include, but is not limited to, potassium persulfate. The metal chlorite can include, but is not limited to, sodium chlorite. The active agent can make up 100% of the bleaching agent 112 or be diluted with a carrier, such as water, glycerol, or propylene glycol. In examples, the active agent is provided in the bleaching agent 112 at a concentration of 6% to 30% (measured by, for example, the volume of the active agent divided by the volume of the carrier multiplied by 100). The bleaching agent can further include auxiliary ingredients including, but not limited to, buffers (e.g., sodium hydroxide), non-bleach whitening agents (e.g., active charcoal, sodium pyrophosphates, hexametaphosphate, sodium hydroxide), thickening agents, flavors, and stabilizers for the active ingredient, as are known in the art. In any event, when the strip 104 is adhered to the plurality of teeth in the oral cavity via the adhesive layer 108, the active ingredient in the bleaching agent 112 breaks down the chromophore molecules in the plurality of teeth (which cause discoloration), thereby whitening the plurality of teeth.

As discussed above, the plurality of scallops 120 are sized and shaped to substantially match the size and shape of the plurality of teeth to which they are adhered. To this end, the plurality of scallops 120 include one or more first scallops sized and shaped to substantially match one or more teeth in a first region of the oral cavity (e.g., the central incisors), one or more second scallops sized and shaped to substantially match one or more teeth in a second region of the oral cavity (e.g., the lateral incisors), one or more third scallops sized and shaped to substantially match one or more teeth in a third region of the oral cavity (e.g., the canines), one or more fourth scallops sized and shaped to substantially match one or more teeth in a fourth region of the oral cavity (e.g., the premolars), and one or more fifth scallops sized and shaped to substantially match one or more teeth in a fifth region of the oral cavity (e.g., the molars). In other examples, however, the plurality of scallops 120 may include two, three, or four different sizes and shapes of scallops instead of five. In any event, because the teeth in the oral cavity have different sizes and shapes, it will be appreciated that the different scallops 120 have different sizes and shapes than one another so as to substantially match the teeth to which they are respectively adhered.

More particularly, the plurality of scallops 120 have different widths so that each individual scallop 120 substantially matches the central incisor, the lateral incisor, the canine, the premolar, or the molar to which that individual scallop 120 is respectively adhered when the strip 104 is adhered to the plurality of teeth. In this example, because the dental treatment device 100 is configured to treat the 14 upper teeth typically in the oral cavity, the plurality of scallops 120 includes 2 first scallops 150 configured to substantially match the central incisors, 2 second scallops 154 configured to substantially match the lateral incisors, 2 third scallops 158 configured to substantially match the canines, 4 fourth scallops 162 configured to substantially match the premolars, and 4 fifth scallops 166 configured to substantially match the molars. Thus, in this example, the first scallops 150 have a first width W_{CE} that substantially matches the width of the central incisors, the second scallops 154 have a second width W_{L} that substantially matches the width of the lateral incisors, the third scallops 158 have a third width W_{CN} that substantially matches the width of the canines, the fourth scallops 162 have a fourth width W_{P} that substantially matches the width of the pre-molars, and the fifth scallops 166 have a fifth width W_{M} that substantially matches the width of the molars. As the exact width of each of these types of teeth will vary from human patient to human patient, the first, second, third, fourth, and fifth widths can also somewhat vary. Generally speaking, however, the first width W_{CE} will be equal to approximately 4-5 mm, the second width W_{L} will be equal to approximately 3-4 mm, the third width W_{CN} will be equal to approximately 4-5 mm, the fourth width W_{P} will be equal to approximately 4.5-5.5 mm, and the fifth width W_{M} will be equal to approximately 5.5-6.5 mm. Preferably, the first width W_{CE} will be equal to approximately 4.5 mm, the second width W_{L} will be equal to approximately 3.5 mm, the third width W_{CN} will be equal to approximately 4.5 mm, the fourth width W_{P} will be equal to approximately 5 mm, and the fifth width W_{M} will be equal to approximately 6 mm, as these values substantially match the different upper teeth in the average human patient having larger teeth. Moreover, in this example, each of the scallops 120 has a height equal to approximately 4-11 mm, as values in this range also substantially match the different upper teeth in the average human patient having larger teeth. It will be appreciated that the exact height of each of the scallops 120 will vary depending upon which of the 14 upper teeth that respective scallop 120 is configured to substantially match.

While not illustrated herein, it will be appreciated that the dental treatment device 100 can include additional components. For example, the dental treatment device 100 can also include a release liner that is selectively attached to the adhesive layer 108 until it is time to adhere the adhesive layer 108 to the plurality of teeth, thereby preventing the strip 104 from inadvertently adhering to another surface.

FIG. 1B illustrates a second example of a dental treatment device 200 constructed in accordance with the principles of the present disclosure. The dental treatment device 200 is structurally and functionally similar to the dental treatment device 100, though the dental treatment device 200 is configured to treat (e.g., bleach or whiten) upper teeth in an oral cavity of a human patient having smaller teeth (e.g., a child). Thus, the dental treatment device 200 has generally smaller dimensions than the dental treatment device 100. First, the dental treatment device 200 has a strip 204 that is shorter in height than the strip 104 of the dental treatment device 100. In this example, the strip 204 has a height H₁ and a height H₃ at its first and second ends 228, 232 equal to approximately 22 mm, and a height H₂ at its middle portion 236 between the first and second ends 228, 232 that is equal to approximately 16 mm. Second, the dental treatment device 200 has a bottom edge 216 defined by a plurality of scallops 220 that have smaller widths than the plurality of scallops 120 in order to substantially match the smaller teeth of the human patient. In this example, the first width W_{CE} will be equal to approximately 3.5-4.5 mm, the second width W_{L} will be equal to approximately 2.5-3.5 mm, the third width W_{CN} will be equal to approximately 3.5-4.5 mm, the fourth width W_{P} will be equal to approximately 4-5 mm, and the fifth width W_{M} will be equal to approximately 5-6 mm. Preferably, the first width W_{CE} will be equal to approximately 4 mm, the second width W_{L} will be equal to approximately 3 mm, the third width W_{CN} will be equal to approximately 4 mm, the fourth width W_{P} will be equal to approximately 4.5 mm, and the fifth width W_{M} will be equal to approximately 5.5 mm, as these values substantially match the different upper teeth in the average human patient having smaller teeth. Moreover, in this example, each of the scallops 220 has a height equal to approximately 4-11 mm, as values in this range also substantially match the different upper teeth in the average human patient having smaller teeth. It will be appreciated that the exact height of each of the scallops 220 will vary depending upon which of the 14 upper teeth that respective scallop 220 is configured to substantially match.

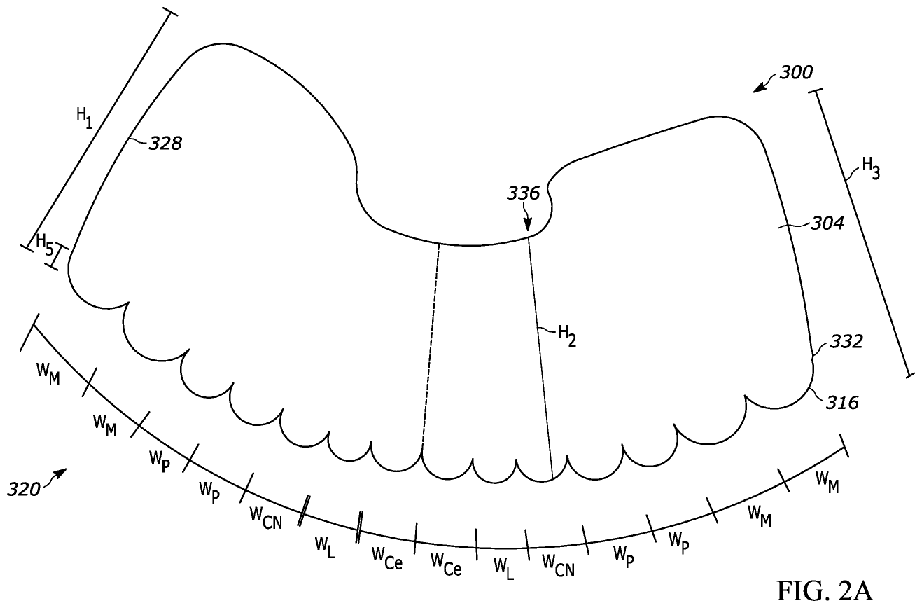

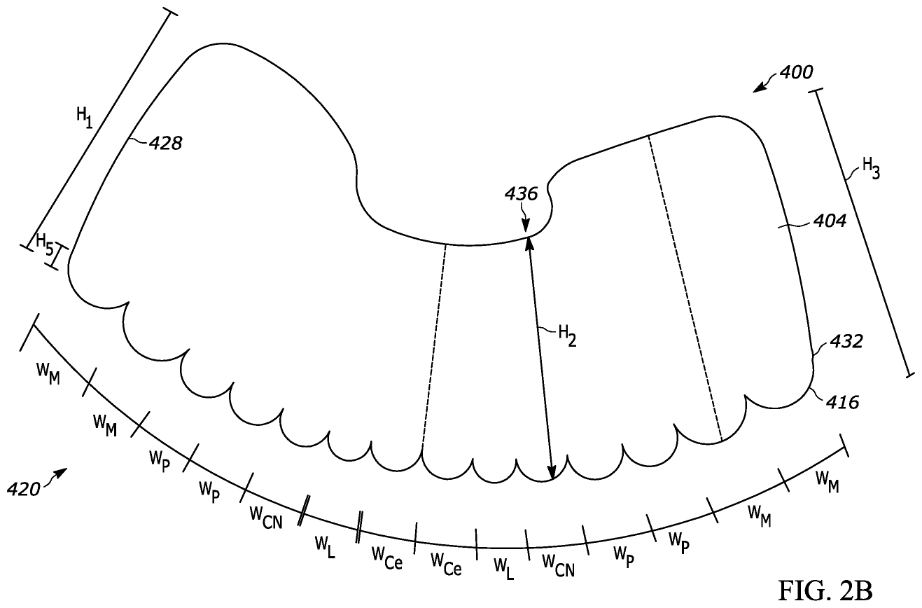

FIG. 2A illustrates a third example of a dental treatment device 300 constructed in accordance with the principles of the present disclosure. The dental treatment device 300 is structurally and functionally similar to the dental treatment device 100, though the dental treatment device 300 is configured to treat (e.g., bleach or whiten) lower teeth in an oral cavity of a human patient having larger teeth (e.g., an adult). However, because lower teeth are generally different in size and shape than upper teeth, the dental treatment device 300 has generally different dimensions than the dental treatment device 100. First, the dental treatment device 300 has a strip 304 that is shorter in height than the strip 104 of the dental treatment device 100. In this example, the strip 304 has a height H₁ and a height H₃ at its first and second ends 328, 332 equal to approximately 25 mm, which matches the strip 104, but a height H₂ at its middle portion 336 between the first and second ends 328, 332 that is equal to approximately 18 mm, less than the strip 104. Second, the dental treatment device 300 has a bottom edge 316 defined by a plurality of scallops 320 that have different widths than the plurality of scallops 120 in order to substantially match the lower teeth of the human patient. In this example, the first width W_{CE} will be equal to approximately 3.5-4.5 mm, the second width W_{L} will be equal to approximately 2.5-3.5 mm, the third width W_{CN} will be equal to approximately 3.5-4.5 mm, the fourth width W_{P} will be equal to approximately 5-6 mm, and the fifth width W_{M} will be equal to approximately 7-8 mm. Preferably, the first width W_{CE} will be equal to approximately 4 mm, the second width W_{L} will be equal to approximately 3 mm, the third width W_{CN} will be equal to approximately 4 mm, the fourth width W_{P} will be equal to approximately 5.5 mm, and the fifth width W_{M} will be equal to approximately 7.5 mm, as these values substantially match the different lower teeth in the average human patient having larger teeth. Moreover, in this example, each of the scallops 320 has a height Hₛ equal to approximately 3-3.5 mm, as these values also substantially match the different lower teeth in the average human patient having larger teeth.

FIG. 2B also illustrates a fourth example of a dental treatment device 400 constructed in accordance with the principles of the present disclosure. The dental treatment device 400 is structurally and functionally similar to the dental treatment device 300, though the dental treatment device 400 is configured to treat (e.g., bleach or whiten) lower teeth in an oral cavity of a human patient having smaller teeth (e.g., a child). Thus, the dental treatment device 400 has generally smaller dimensions than the dental treatment device 300. First, the dental treatment device 400 has a strip 404 that is shorter in height than the strip 304 of the dental treatment device 300. In this example, the strip 404 has a height H₁ and a height H₃ at its first and second ends 428, 432 equal to approximately 22 mm, and a height H₂ at its middle portion 436 between the first and second ends 428, 432 that is equal to approximately 15 mm. Second, the dental treatment device 400 has a bottom edge 416 defined by a plurality of scallops 420 that have smaller widths than the plurality of scallops 320 in order to substantially match the smaller lower teeth of this human patient. In this example, the first width W_{CE} will be equal to approximately 3.5-4.5 mm, the second width W_{L} will be equal to approximately 2.5-3.5 mm, the third width W_{CN} will be equal to approximately 3.5-4.5 mm, the fourth width W_{P} will be equal to approximately 4-5 mm, and the fifth width W_{M} will be equal to approximately 6-7 mm. Preferably, the first width W_{CE} will be equal to approximately 4 mm, the second width W_{L} will be equal to approximately 3 mm, the third width W_{CN} will be equal to approximately 4 mm, the fourth width W_{P} will be equal to approximately 4.5 mm, and the fifth width W_{M} will be equal to approximately 6.5 mm, as these values substantially match the different lower teeth in the average human patient having smaller teeth. Moreover, in this example, each of the scallops 420 has a height Hₛ equal to approximately 3 mm, as this value also substantially matches the height of the lower teeth in the average human patient having smaller teeth.

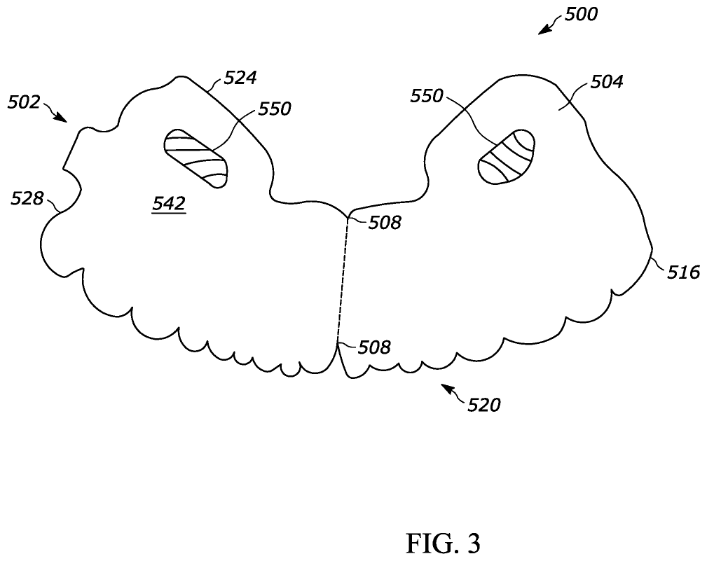

FIG. 3 illustrates a fifth example of a dental treatment device 500 constructed in accordance with the principles of the present disclosure. The dental treatment device 500 is similar to the dental treatment device 100, in that the dental treatment device 500 is also configured to treat (e.g., bleach or whiten) upper teeth in an oral cavity of a human patient having larger teeth (e.g., an adult). However, the dental treatment device 500 includes several additional components that facilitate more effective usage of the dental treatment device 500.

First, the dental treatment device 500 includes one or more tabs configured to allow the human patient (or a dental professional helping the human patient) to easily grip the dental treatment device 500 so as to facilitate application of the dental treatment device 500 to the plurality of teeth or removal of the dental treatment device 500 from the plurality of teeth. In this example, the dental treatment device 500 includes a single tab 502 that extends outward from a first end 528 of the strip 504 between the top edge 524 and the bottom edge 516 of the strip 504. In other examples, however, the dental treatment device 500 can include additional tabs and/or the tab(s) can be disposed elsewhere.

Second, the dental treatment device 500 includes one or more relief cuts formed in the strip 504 to allow the strip 504 to be folded over the plurality of teeth when the adhesive layer 108 is adhered to the plurality of teeth. In this example, the dental treatment device 500 includes a pair of relief cuts 508 formed in the strip 504 in the middle portion of the strip 504 (and, more particularly, at a position approximately centrally located between the first end 528 and a second end 532 of the strip 504), with one relief cut 508 formed in the top edge 524 and the other relief cut 508 formed in the bottom edge 516. In other examples, however, the dental treatment device 500 can include more or less relief cuts and/or the relief cut(s) can be formed elsewhere.

Third, the dental treatment device 500 includes means for sublingually delivering a medicament to the oral cavity. More particularly, the means for sublingually delivering the medicament to the oral cavity is positioned on the strip 504 so as to be immediately adjacent the human patient's tongue when the strip 504 is employed to treat the upper teeth in the oral cavity of the human patient. In turn, the medicament is delivered to the human patient via the patient's tongue and/or the human patient's oral tissue immediately adjacent the dental treatment device 500.

In this example, the means for sublingually delivering the medicament to the oral cavity takes the form of a pair of patches 550 each impregnated with the medicament and disposed on a second side 542 of the strip 504 opposite a first side 540, which is partially or substantially entirely coated with the adhesive layer 108 and the bleaching agent 112. In this example, the patches 550 are disposed on opposite ends of the strip 504, with one of the patches 550 being disposed immediately adjacent the first end 528 and the other of the patches 550 being disposed immediately adjacent the second end 532, such that the patches 550 will be aligned with the molars of the human patient during use. In other examples, however, the means for sublingually delivering the medicament to the oral cavity can vary from the patches 550. In some examples, the means for sublingually delivering the medicament to the oral cavity can instead take the form of a pouch, a capsule, a pocket, or other receptacle that is impregnated with or contains the medicament. Moreover, in some examples, the means for sublingually delivering the medicament to the oral cavity can be positioned so as to be aligned with one or more different teeth (e.g., the pre-molars) during use.

As used herein, the term “medicament” refers to any substance that, when administered to a subject, such as a human patient, aids in the treatment or prevention of an ailment (or a symptom thereof) of the subject. Medicaments can include pharmaceutical agents, nutraceutical agents, and cosmetic agents. Examples of medicaments include, but are not limited to, anti-inflammatory agents, anti-infective agents, anti-bacterial agents, pain medication, breath fresheners, nutrients, supplements (e.g., melatonin), extracts, or mixtures thereof. The medicament can be naturally occurring or synthetic. Naturally occurring medicaments can include, for example, plant extracts. Examples of naturally occurring medicaments include, but are not limited to, grapeseed extract, cannabidiol (cannabis extract), Ginkgo biloba extracts, green tea extracts, and curcumin. The medicament may be in liquid form (e.g., a free-flowing liquid, a gel, an oil, a foam, a mousse, or a paste), solid form, or in some other form.

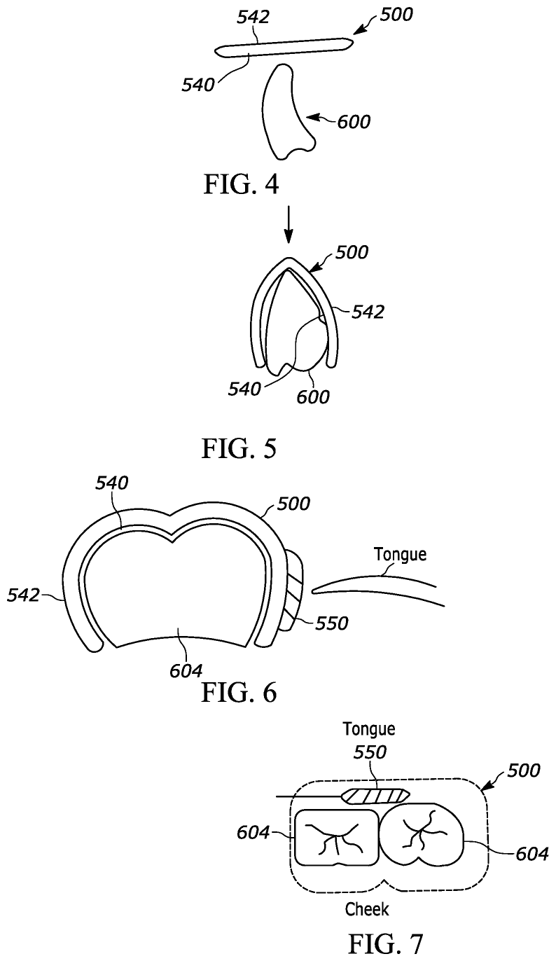

FIGS. 4-7 will now be used to discuss how the dental treatment device 500 is applied to the plurality of teeth (upper teeth in this example), even though FIGS. 4-7 only show one lateral incisor 600 and two molars 604. Initially, as illustrated in FIG. 4, the dental treatment device 500, which is initially flat, is positioned over the incisor 600 and the rest of the plurality of teeth. Next, the dental treatment device 500 is manipulated (e.g., bent) so that the strip 504 engages the incisor 600 and the rest of the plurality of teeth in the manner illustrated in FIG. 5. As such, a portion of the first side 540 of the strip 504 faces (and engages) the front side of each of the plurality of teeth, the remaining portion of the first side 540 of the strip 504 faces (and engages) the rear side of each of the plurality of teeth, a portion of the second side 542 of the strip 504 faces outward, away from the plurality of teeth, and the remaining portion of the second side 542 of the strip 504 faces (and may contact) the tongue, as illustrated in FIGS. 5 and 6. In turn, the adhesive layer 108 on the first side 540 of the strip 504 engages both the front and rear sides of each of the incisor 600 and the rest of the plurality of teeth, thereby adhering the strip 504 to the plurality of teeth. Moreover, as the strip 504 is adhered to the plurality of teeth for a pre-determined period of time, the bleaching agent 112 on the first side 540 of the strip 504 breaks down the chromophore molecules in the plurality of teeth, thereby treating (e.g., whitening) those teeth. Importantly, however, because the plurality of scallops 520 are sized and shaped to substantially match the size and shape of the plurality of teeth to which they are adhered, respectively, the strip 504 substantially, if not entirely, covers each of the plurality of teeth, and, at the same time, does not extend beyond the plurality of teeth and into engagement with gum tissue immediately adjacent thereto, as illustrated in FIGS. 5 and 6. Further, as illustrated in FIGS. 6 and 7, the patches 550, which are disposed on the second side 542 of the strip 504, are positioned inward of the plurality of teeth (the molars 604 in FIGS. 6 and 7) and immediately adjacent the tongue. In turn, the medicament can be delivered to the human patient via the patient's tongue and/or the human patient's oral tissue immediately adjacent the patches 550.

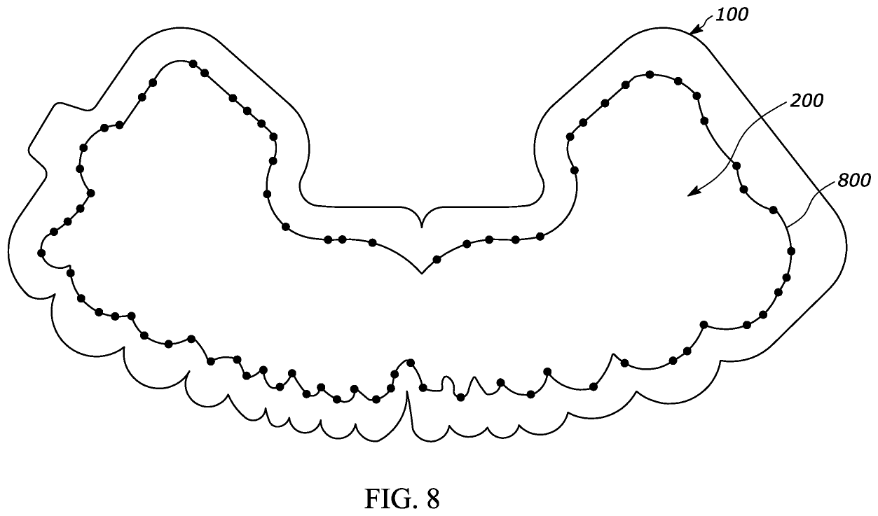

It will be appreciated that any of the dental treatment devices described herein (e.g., the dental treatment device 100) can also include one or more tabs, one or more relief cuts, and/or means for sublingually delivering a medicament to the oral cavity, just as discussed in connection with the dental treatment device 500. It will also be appreciated that the dental treatment devices described herein can be applied to the plurality of teeth in a similar manner as discussed above in connection with the dental treatment device 500. Finally, it will also be appreciated that two or more of the dental treatment devices (e.g., the dental treatment device 100 and the dental treatment device 200) can be packaged together, with the dental treatment device 200 removably coupled to the dental treatment device 100 (e.g., via perforations 800), as illustrated in FIG. 8. In turn, the human patient can, for example, use the dental treatment device that best fits his/her teeth while discarding the remaining dental treatment device.

Throughout this specification, structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

As used herein, the terms “comprises,” “comprising,” “may include,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

1. A dental treatment device configured to treat a plurality of teeth in an oral cavity of a human patient, the dental treatment device comprising:
a strip adapted to engage the plurality of teeth in the oral cavity, the strip having a top edge and a bottom edge;
an adhesive layer disposed on a first side of the strip between the top edge and the bottom edge, the adhesive layer configured to adhere to the plurality of teeth for a pre-determined period of time; and
a bleaching agent disposed on the first side of the strip between the top edge and the bottom edge, the bleaching agent configured to bleach the plurality of teeth when the adhesive layer is adhered to the plurality of teeth for the pre-determined period of time,
wherein the bottom edge is defined by a plurality of scallops sized to substantially match the plurality of teeth, such that the plurality of scallops are configured to minimize contact between the bleaching agent and gum tissue adjacent the plurality of teeth in the oral cavity.

2. The dental treatment device of claim 1, wherein the plurality of scallops comprise one or more first scallops and one or more second scallops having a different size than the one or more first scallops, the one or more first scallops sized to substantially match one or more teeth in a first region of the oral cavity, and the one or more second scallops sized to substantially match one or more teeth in a second region of the oral cavity.

3. The dental treatment device of claim 2, wherein the one or more first scallops have a first width, and wherein the one or more second scallops have a second width different from the first width.

4. (canceled)

5. (canceled)

6. The dental treatment device of claim 1, further comprising a tab extending outward from the strip between the top edge and the bottom edge, the tab configured to facilitate application of the strip to the plurality of teeth or removal of the strip from the plurality of teeth.

7. The dental treatment device of claim 1, further comprising one or more relief cuts formed in the strip to allow the strip to be folded over the plurality of teeth when the adhesive layer is adhered to the plurality of teeth.

8. The dental treatment device of claim 1, wherein the strip has a first end portion, a second end portion opposite the first end portion, and a middle portion disposed between the first and second end portions, wherein the first end portion has a first height, and wherein the middle portion has a second height less than the first height.

9. A dental treatment device configured to treat a plurality of teeth in an oral cavity of a human patient, the dental treatment device comprising:
a strip adapted to engage the plurality of teeth in the oral cavity, the strip having a top edge and a bottom edge;
an adhesive layer disposed on a first side of the strip between the top edge and the bottom edge, the adhesive layer configured to adhere to the plurality of teeth for a pre-determined period of time;
a bleaching agent disposed on the first side of the strip between the top edge and the bottom edge, the bleaching agent configured to bleach the plurality of teeth when the adhesive layer is adhered to the plurality of teeth for the pre-determined period of time;
a tab extending outward from the strip between the top edge and the bottom edge, the tab configured to facilitate application of the strip to the plurality of teeth or removal of the strip from the plurality of teeth; and
one or more relief cuts formed in the strip to allow the strip to be folded over the plurality of teeth when the adhesive layer is adhered to the plurality of teeth for the pre-determined period of time,
wherein the bottom edge is defined by a plurality of scallops sized to substantially match the plurality of teeth, such that the plurality of scallops are configured to minimize contact between the bleaching agent and gum tissue adjacent the plurality of teeth in the oral cavity.

10. The dental treatment device of claim 9, wherein the plurality of scallops comprise one or more first scallops and one or more second scallops having a different size than the one or more first scallops, the one or more first scallops sized to substantially match one or more teeth in a first region of the oral cavity, and the one or more second scallops sized to substantially match one or more teeth in a second region of the oral cavity.

11. The dental treatment device of claim 10, wherein the one or more first scallops have a first width, and wherein the one or more second scallops have a second width different from the first width.

12. (canceled)

13. (canceled)

14. The dental treatment device of claim 9, wherein the strip has a first end portion, a second end portion opposite the first end portion, and a middle portion disposed between the first and second end portions, wherein the first end portion has a first height, and wherein the middle portion has a second height less than the first height.

15. A dental treatment device configured to treat a plurality of teeth in an oral cavity of a human patient, the dental treatment device comprising:
a strip adapted to engage the plurality of teeth in the oral cavity, the strip having a top edge and a bottom edge;
an adhesive layer disposed on a first side of the strip between the top edge and the bottom edge, the adhesive layer configured to adhere to the plurality of teeth for a pre-determined period of time;
a bleaching agent disposed on the first side of the strip between the top edge and the bottom edge, the bleaching agent configured to bleach the plurality of teeth when the adhesive layer is adhered to the plurality of teeth for the pre-determined period of time; and
means for sublingually delivering a medicament to the oral cavity, the means for sublingually delivering the medicament to the oral cavity disposed on a second side of the strip opposite the first side.

16. The dental treatment device of claim 15, wherein the means for sublingually delivering the medicament comprises a patch containing the medicament.

17. The dental treatment device of claim 15, wherein the means for sublingually delivering the medicament comprises a pouch containing the medicament.

18. The dental treatment device of claim 15, wherein the medicament comprises a liquid.

19. The dental treatment device of claim 18, wherein the liquid comprises a free-flowing liquid, a gel, a foam, a mousse, or a paste.

20. The dental treatment device of claim 15, wherein the medicament comprises an extract.

21. The dental treatment device of claim 20, wherein the extract comprises cannabidiol.

22. The dental treatment device of claim 15, wherein the means for sublingually delivering the medicament is disposed immediately adjacent the top edge of the strip.

23. The dental treatment device of claim 15, wherein when the adhesive layer is adhered to the plurality of teeth for the pre-determined period of time, the means for sublingually delivering the medicament is disposed immediately adjacent a tongue of the human patient.

24. The dental treatment device of claim 15, wherein the strip is shaped and sized to substantially match the plurality of teeth to minimize contact between the bleaching agent and gum tissue adjacent the plurality of teeth in the oral cavity.

25. The dental treatment device of claim 24, wherein the bottom edge is defined by a plurality of scallops shaped and sized to substantially match the plurality of teeth.
